(19) United States
(12) Patent Application Publication
(10) Pub. No.: US 2014/0089071 A1
(43) Pub. Date: Mar. 27, 2014

(54) SMART VOUCHER SYSTEMS AND METHODS

(71) Applicant: A.R.N.S MARKETING LTD, Even Yehuda (IL)

(72) Inventors: Ariel Cohen, Petah Tikva (IL); Maor Tal, Holon (IL)

(73) Assignee: A.R.N.S MARKETING LTD, Even Yehuda (IL)

(21) Appl. No.: 14/024,818

(22) Filed: Sep. 12, 2013

Related U.S. Application Data
(60) Provisional application No. 61/704,449, filed on Sep. 22, 2012.

(51) Int. Cl. G06Q 30/02

(52) U.S. Cl. CPC G06Q 30/0225
USPC 705/14.26

(57) ABSTRACT

Method for efficient use of meal vouchers comprising issuing a unique meal voucher having a per diem value and preset use criteria, verifying voucher validity for use under at least one preset criterion, and, if the preset criterion is satisfied, allowing the use of the voucher. Use criteria may include a day and time limitation on voucher use, redemption of the voucher for goods other than a meal and/or accumulation of the voucher per diem value to a preset sum and/or over a preset period. A system implementing the method includes a dedicated server running applications which enable interaction between employers, employees, meal and non-meal suppliers and non-employee users for issue, distribution and efficient use of meal vouchers which can also be redeemed for goods other than meals and/or have their per diem value accumulated before redemption.

### CROSS REFERENCE TO RELATED APPLICATIONS

This application is related to and hereby claims the priority benefit of U.S. Provisional Patent Application No. 61/704,449 having the same title and filed Sep. 22, 2012, which is incorporated herein by reference in its entirety.

### FIELD

Embodiments disclosed herein relate in general to merchandising systems and methods and in particular to methods for using meal (or “food”) vouchers issued by employers to employees or purchased by non-employee consumers more efficiently, in a way benefitting employers, employees, food establishments and non-food establishments or suppliers.

### BACKGROUND

Vouchers have become a very acceptable way of conducting business. Meal vouchers are known in various industries, particularly the high tech industry, where some employers provide such vouchers to their employees daily. Such vouchers can generally be redeemed only for a meal (e.g. lunch), sometimes at restricted food establishments (e.g. restaurants). Normally, an employer issuing the voucher has no control over the time the employee leaves work for lunch or returns to work after lunch. Conditions (or lack thereof) imposed on voucher use lead to waste. Restrictions (such as use only for meals at a certain restaurant) lead to employee frustration.

Therefore, there is a need for and it would be advantageous to have systems and methods for more efficient and controlled use of meal vouchers issued by employers to employees, which will benefit employers, employees and third party users as well as non-meal suppliers. The benefits may include reduced employer costs and reduced waste in meal times, increased business to meal and non-meal establishments or suppliers and additional and better choices for voucher use by the employees.

### SUMMARY

Embodiments disclosed herein teach methods and systems for efficient use of meal vouchers which benefit employers issuing the vouchers, employees receiving the vouchers, food establishments and non-food suppliers. A meal voucher with a “per-diem” value is issued to an employee (or may be purchased by a third party). The “per-diem” value is the sum allowed to be spent on a meal during one day. The employee (or third party purchaser) is allowed to purchase goods or services other than a meal under certain criteria set by the employer (or other voucher issuer). In an embodiment, the voucher may be used to purchase a coupon redeemable for a meal or other goods or services, the coupon providing an additional discount. Further, under certain preset criteria, the employee (or third party user) may be allowed to accumulate the per diem voucher value and use the accumulated sum to purchase a meal or other goods or services.

In an embodiment there is provided a method for efficient use of meal vouchers, implemented using a dedicated server, the method comprising the steps of issuing a unique meal voucher having a per diem value and at least one preset use criterion, verifying voucher validity for use under the at least one preset criterion, and, if the preset criterion is satisfied, allowing the use of the voucher.

In an embodiment, the preset criterion includes use on a specific day and the step of allowing includes allowing the use of the voucher only during the specific day.

In an embodiment, the preset criterion further includes use during a specific time period and the allowing includes allowing the use of the voucher only during the specific time period on the specific day.

In an embodiment, the preset criterion includes use for purchasing goods or services other than a meal and the allowing includes allowing the use of the voucher for purchasing such goods or services.

In an embodiment, the preset criterion includes allowing accumulation of the per diem value to a preset sum or during a preset period.

In an embodiment there is provided a method for efficient use of meal vouchers, implemented using a dedicated server, the method comprising the steps of issuing a unique meal voucher having a per diem value, checking if the voucher is valid for a purpose other than purchasing a meal, and, if yes, allowing use of the voucher for the purpose other than purchasing a meal.

In an embodiment, the method further comprises checking if the per diem value can be accumulated under a preset criterion, and if yes, allowing use of the accumulated per diem value for the purpose other than purchasing a meal.

In an embodiment, the preset criterion includes a preset sum.

In an embodiment, the preset criterion includes a preset time period.

In an embodiment, the preset criterion includes a combination of a preset sum and a preset time period.

In an embodiment, the step of issuing is performed by an employer and wherein the meal voucher is issued to an employee.

In an embodiment there is provided a system for efficient use of meal vouchers comprising a dedicated voucher management server configured to, by an employer and to an employee, issue, validate and control a meal voucher having a per diem value, wherein the meal voucher may be used to purchase goods or services other than a meal, an employer interface and an employee interface, wherein both interfaces are used to communicate with the dedicated voucher server.

In an embodiment, the system further comprises a supplier interface enabling a supplier to redeem a voucher issued through the dedicated voucher server, and a third party user interface enabling third part non-employee users to purchase and use a voucher issued through the dedicated server.

In an embodiment, the meal voucher per diem value can be accumulated to a preset sum.

In an embodiment, the meal voucher per diem value can be accumulated over a preset time period.

### BRIEF DESCRIPTION OF THE DRAWINGS

The invention is herein described, by way of example only, with reference to the accompanying drawings, wherein:

FIG. 1 shows in a flow chart an embodiment of a method disclosed herein;

FIG. 2 shows in a flow chart more details of the method embodied in FIG. 1;

FIG. 3 shows schematically an embodiment of a system disclosed herein.

### DETAILED DESCRIPTION

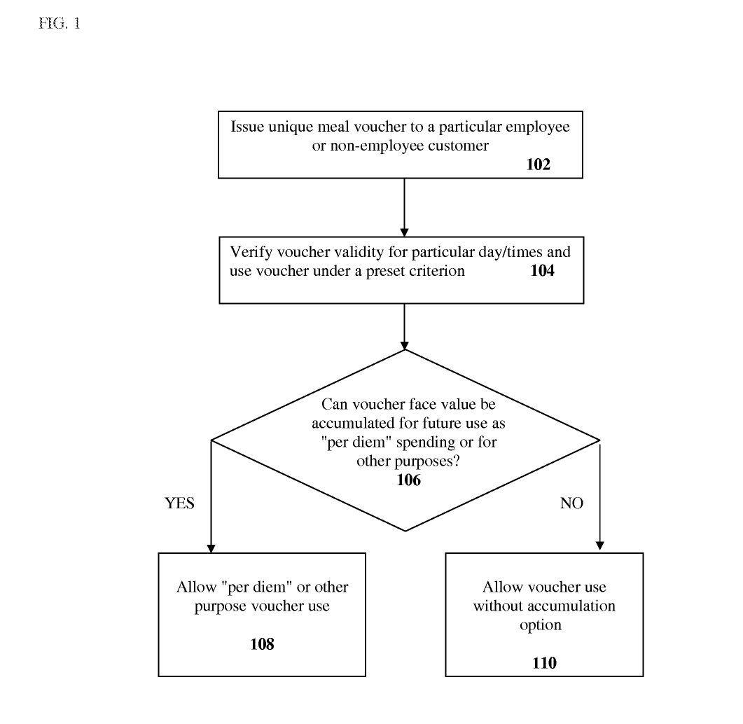

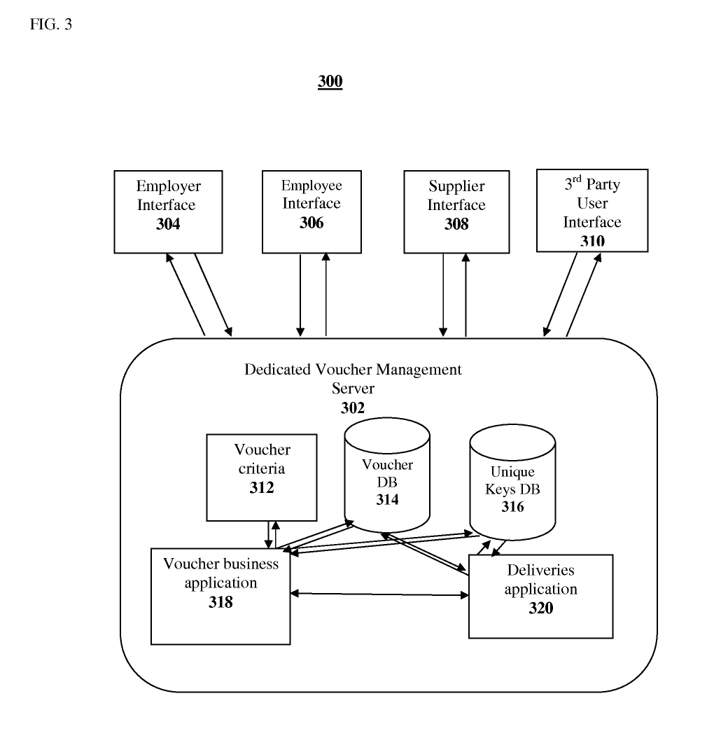

FIG. 1 shows in a flow chart an embodiment of a method disclosed herein. The method allows a “voucher issuer” (for example an employer) to provide “meal vouchers” (or simply “vouchers”) to an “employee”. Hereinafter, the term “employee” may also refer to non-employee consumers who purchase a voucher through the system described in FIG. 3 and use (redeem) it according to a method described herein. For simplicity, the description continues with detailed reference to an “employer” as a voucher issuer and to an “employee” as an entity to whom the voucher is issued. As used hereinafter, a “meal voucher” refers to a voucher which may be redeemed by an employee under employer set criteria (see below), which include, in some embodiments, conversion of voucher redemption for a meal to voucher redemption for goods or services other than a meal (also referred to as “non-meal” goods or services). In an embodiment, a voucher may be used to purchase at a discount a coupon redeemable for a meal or non-meal goods or services, thereby providing additional savings and flexibility of use.

Each voucher has a per diem value. In some embodiments, the per diem value can be accumulated to a preset sum, with voucher use defined by the employer set criteria. Such criteria may include time and/or use limitations. Exemplary time limitations for a particular voucher may include: “valid for particular hours on the day of issue”. “valid for particular hours on a particular day other than day of issue”, “valid for the entire day of issue”, “valid for a particular day of the week”, or “valid for the entire week”. Use limitation criteria may include “allow face value accumulation to a preset sum”, “allow use only in particular food establishments” (for example for Kosher meals) or “allow use of voucher for goods or services other than a meal”, possibly coupled with a time limitation as above, etc.

With regard to both per diem redemption and accumulated value redemption (direct or through coupon purchases), exemplary non-meal goods may include clothing, cosmetics, shoes, cell-phones, computers, airline tickets, show tickets, consumer electronics, home furnishings, etc. Exemplary non-meal services may include vacations, spa treatments, etc.

In step 102, a unique voucher X is issued by the employer (which uses exemplarily an employer interface 306, FIG. 3) and is sent to a particular employee Y. In step 104, a verification is performed regarding the voucher's validity for use on particular days and/or times and under at least one preset criterion. If the validity is verified, the voucher may used by the employee under one or more preset criteria or expires. In step 106, a check is performed whether a validated voucher's per diem value may be accumulated for future use over a preset time period and/or for up to a preset sum. The future use may be a “per diem” use or a purchase of a meal or non-meal goods or services. If YES in check 106, then in step 108 the voucher is allowed for use through a voucher business application 318 or through a deliveries web application 320 running on a dedicated server 302, see FIG. 3. If NO in check 106, then in step 110 the voucher is allowed for use according to its per diem value under at least one preset criterion. Steps 102, 104, 106 and 110 are performed by voucher business application 318.

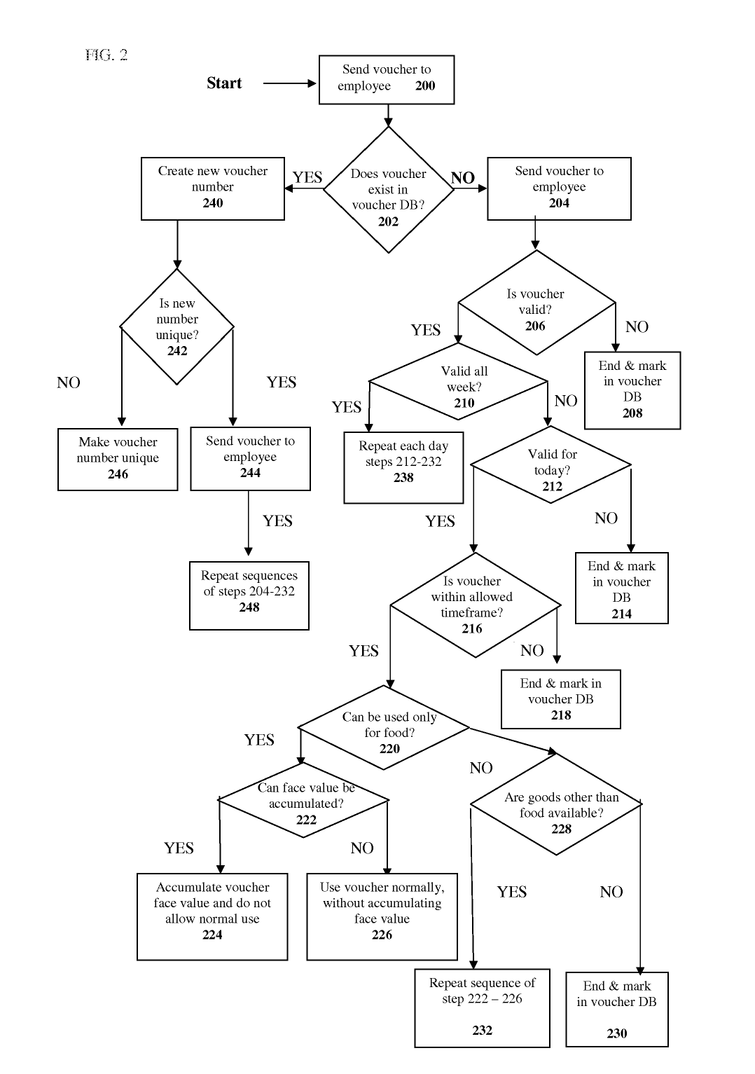

FIG. 2 shows in a flow chart more details of the method embodied in FIG. 1 In step 200, voucher X having a voucher ID assigned thereto (“voucher number”) is issued by an employer to employee Y. In step 202, a check is performed to determine whether the voucher (i.e. its ID) exists in a voucher database (DB) 314, FIG. 3. If NO (voucher ID is unique), voucher X is sent to employee Y in step 204. A check is then run in step 206 to determine whether the voucher is valid. If NO (voucher not valid), the process ends and the voucher is marked in the voucher DB in step 208. If YES in step 206 (voucher is valid), a check is performed in step 210 on whether the validity is for the entire week. If NO in step 210, a check is performed in step 212 on whether the voucher is valid for the present day (“today”). If NO in step 212 (voucher is valid for some days of the week but not for the present day), the process ends and the voucher is marked in the voucher DB in step 214. If YES in step 212, a check is performed in step 216 on whether the validity is for particular hours (e.g. between 12 am and 13:59 pm) on the present day. If NO in step 216, the process ends and the voucher is marked in the voucher DB in step 218. If YES in step 216, a check is performed in step 220 on whether the voucher can be used on the present day only for meal purchase, or if it can also be used for non-meal purchases. If YES in step 220, a further check is performed in step 222 on whether the voucher's per diem value can be accumulated. If YES in step 222, the per diem value is accumulated in step 224 for use under at least one preset criterion. If NO in step 222, then in step 226 the voucher is allowed for meal purchase only under at least one preset criterion (e.g. during a certain time period, in certain restaurants, for certain types of food, etc.).

Returning now to step 220, if NO in step 220 (voucher not limited to meal purchase), a check is performed in step 228 on whether other non-meal goods or services specified in the employer criteria are available, and if NO, the process ends and the voucher is marked in the voucher DB in step 230. If YES in step 228, then in step 232 the sequence in steps 222-226 is repeated

Returning to step 210, if the answer is YES (voucher valid for entire week), then the process continues in step 238 with a repetition of steps 212-232 on every day of the week on which the voucher is valid.

Returning now to step 202, if YES (voucher ID exists in voucher DB), a new voucher ID number is created for voucher X in step 240. The new number may exemplarily be created by adding a digit to the existing number. Other methods to create a unique number may also be used. A check is performed in step 242 on whether the new number is unique. If YES, the voucher is sent to employee Y in step 244, and the sequence of steps 204-232 is repeated (shown as a general step marked 248). If NO in step 242, steps 202 and 240 are repeated until a unique new ID number is created for voucher X (check in 242 yields “YES”), after which the voucher s sent to the employee and the sequence of steps 204-232 is repeated.

FIG. 3 shows schematically an embodiment of a system 300 disclosed herein. System 300 comprises a dedicated voucher management server 302 (exemplarily used in a “cloud” environment) coupled to a number of user interfaces. These include an employer user interface 304, an employee user interface 306, a supplier interface 308 and a third party (e.g. non-employee customer) user interface 310. Interfaces 304, 306 and 310 may exemplarily be computer terminals or point-of-sale (POS) devices. Server 302 is configured to issue, validate and control the use of meal vouchers which can, under certain criteria, be used for purchases of goods or services other than meals and/or for accumulation of per diem value for purchases of meals or other goods/services. The server includes a voucher criteria module 312 for storage of employer (or voucher issuer) criteria, a voucher database (DB) 314 for storage of all vouchers and a unique voucher number DB 316 for storage of unique voucher numbers. The server further includes a voucher business application (or “module”) 318 and a deliveries application 320. Voucher business application 318 has functionalities as explained above re. FIG. 1. Deliveries application 320 allows use of the vouchers under the employer or voucher issuer set criteria, and in particular use for purchasing goods or services other than meals.

In contrast with known art systems, server 302 provides therefore provides unprecedented functionality and flexibility for interaction between employers, employees and meal or other goods or service suppliers, for more efficient and beneficial use of meal vouchers. The more efficient and beneficial use may lead to increased employer cost savings and increased control over employee meal times, increased business to both meal and non-meal suppliers and additional and better choices for voucher use by the employees.

### EXAMPLE 1

Employer X provides a unique meal voucher to employee A, who receives the voucher through a SMS message to his/her cell-phone at 11 am on the day of issue. The voucher has a per diem value of $35 and may be used only for lunch between 12 am and 2 pm on the day of issue at three restaurants close to the workplace of the employees. By setting the transmission time (11 am) and limiting the use of the vouchers to meals at one of the three restaurants, the employer has good control on the lunch time of the employee (both when he/she leaves for lunch and on the time spent at lunch).

### EXAMPLE 2

Employer Y provides on Sunday morning unique meal vouchers to employees A, B and C. All vouchers have a per diem value of $35. The voucher of employee A is valid for use only for a Kosher meal at any of three establishments on the Sunday or Thursday of the week of issue. The per diem value cannot be accumulated. The voucher of employee B is valid for use either for a meal at any of three restaurants on each day of the week between 12 am and 13:59 pm, or for purchase of goods up to the per diem value during the week of issue. The per diem value cannot be accumulated. The voucher of employee C is valid for use for meals every day of the week between 12 am and 13:59 pm at any restaurant registered through the supplier interface, and if not used that week, remain valid for a period of a month from the day of issue, during which time its per diem value can be added to that of additional vouchers issued to employee C for purchases of meals or other goods, for example clothing sold by a supplier registered through the supplier interface.

In summary, the methods and system disclosed herein provide a number of advantages to their various users:

1. Employees can accumulate the per diem value of meal vouchers up to preset sums and/or over preset time periods. Moreover, under certain criterions, employees may use meal vouchers (either at per diem value or accumulated value) for purchasing goods other than meals.
2. Employers/meal voucher issuers achieve savings and tighter control over meal expenses and time spent by employees on meals.
3. Non-food establishments benefit from additional meal voucher holders as customers who can redeem their meal vouchers for other products.

While this disclosure describes a limited number of embodiments of the invention, it will be appreciated that many variations, modifications and other applications of such embodiments may be made.

1. A method for efficient use of meal vouchers, implemented using a dedicated server, the method comprising the steps of:
a) issuing a unique meal voucher having a per diem value and at least one preset criterion;
b) verifying voucher validity for use under the at least one preset criterion and, if the at least one preset criterion is satisfied;
c) allowing the use of the voucher.

2. The method of claim 1, wherein the preset criterion includes use on a specific day and wherein the step of allowing includes allowing the use of the voucher only during the specific day.

3. The method of claim 2, wherein the preset criterion further includes use during a specific time period and wherein the allowing the use of the voucher only during the specific day includes allowing the use of the voucher only during the specific time period on the specific day.

4. The method of claim 1, wherein the preset criterion includes use for purchasing goods or services other than a meal and wherein the step of allowing includes allowing the use of the voucher for purchasing such goods or services.

5. The method of claim 1, wherein the preset criterion includes accumulation of the per diem value to a preset sum or during a preset period.

6. A method for efficient use of meal vouchers, implemented using a dedicated server, the method comprising the steps of:
a) issuing a unique meal voucher having a per diem value;
b) checking is the voucher is valid for a purpose other than purchasing a meal, and, if yes;
c) allowing use of the voucher for the purpose other than purchasing a meal.

7. The method of claim 6, wherein the step of allowing use of the voucher for the purpose other than purchasing a meal includes allowing a purchase of non-meal goods.

8. The method of claim 6, wherein the step of allowing use of the voucher for the purpose other than purchasing a meal includes allowing a purchase of services.

9. The method of claim 6, further comprising the step of, after step (b), checking if the per diem value can be accumulated under at least one preset criterion, and if yes, wherein the step of allowing use includes allowing use of the accumulated per diem value for the purpose other than purchasing a meal.

10. The method of claim 9, wherein the preset criterion includes a preset sum.

11. The method of claim 9, wherein the preset criterion includes a preset time period.

12. The method of claim 9, wherein the preset criterion includes a combination of a preset sum and a preset time period.

13. The method of claim 9, wherein the step of allowing use of the voucher for the purpose other than purchasing a meal includes allowing a purchase of non-meal goods.

14. The method of claim 9, wherein the step of allowing use of the voucher for the purpose other than purchasing a meal includes allowing a purchase of services.

15. The method of claim 6, wherein the step of issuing is performed by an employer and wherein the meal voucher is issued to an employee.

16. A system for efficient use of meal vouchers comprising:
a) a dedicated voucher management server configured to, by an employer and to an employee, issue, validate and control a meal voucher having a per diem value, wherein the meal voucher may be used to purchase goods or services other than a meal;
b) an employer interface; and
c) an employee interface; wherein both interfaces are used to communicate with the dedicated voucher server.

17. The system of claim 16, further comprising a supplier interface enabling a supplier to redeem a voucher issued through the dedicated voucher server, and a third party user interface enabling third part non-employee users to purchase and use a voucher issued through the dedicated server.

18. The system of claim 16, wherein the meal voucher per diem value can be accumulated to a preset sum.

19. The system of claim 16, wherein the meal voucher per diem value can be accumulated over a preset time period.
